(19) United States
(12) Patent Application Publication
(10) Pub. No.: US 2022/0163342 A1
(43) Pub. Date: May 26, 2022

(54) NAVIGATION SERVER, NAVIGATION PROGRAM, AND NAVIGATION SYSTEM

(71) Applicant: TOYOTA JIDOSHA KABUSHIKI KAISHA, Toyota-shi (JP)

(72) Inventors: Ayano KIMURA, Susono-shi (JP); Hikaru SHIOZAWA, Susono-shi (JP); Toshiya HASHIMOTO, Miyoshi-shi (JP); Chuya OGAWA, Susono-shi (JP); Yuta MANIWA, Susono-shi (JP)

(73) Assignee: TOYOTA JIDOSHA KABUSHIKI KAISHA, Toyota-shi (JP)

(21) Appl. No.: 17/462,969

(22) Filed: Aug. 31, 2021

(30) Foreign Application Priority Data
Nov. 24, 2020 (JP) 2020-194701

(51) Int. Cl. G01C 21/36; G08G 1/00; B60L 53/62; B60L 53/65; B60L 58/13; B60W 30/06

(52) U.S. Cl. CPC G01C 21/3679; G08G 1/20; B60W 30/06; B60L 53/65; B60L 58/13; B60L 53/62

(57) ABSTRACT

A navigation server includes a processor configured to acquire information on the charging mode of a battery included in each of the plurality of vehicles and to select a charging space for each of the plurality of vehicles based on the acquired information.

### CROSS-REFERENCE TO RELATED APPLICATION

This application claims priority to Japanese Patent Application No. 2020-194701 filed on Nov. 24, 2020, incorporated herein by reference in its entirety.

### BACKGROUND

### 1. Technical Field

The present disclosure relates to a navigation server, a navigation program, and a navigation system.

### 2. Description of Related Art

Japanese Unexamined Patent Application Publication No. 2020-068573 (JP 2020-068573 A) discloses an electric vehicle that can be charged by a charger in both the AC charging mode and the DC charging mode.

### SUMMARY

There is a case in which two electric vehicles, a first electric vehicle with a battery that can be charged in any of a plurality of charging modes and a second electric vehicle with a battery that can be charged in the same charging mode that is one of the plurality of charging modes, are charged in the same charging space where a charger that supports that same charging mode is provided. In this case, one of the electric vehicles must wait to charge the battery until the other electric vehicle has finished charging the battery.

In view of the problem described above, the present disclosure provides a navigation server, a navigation program, and a navigation system that can reduce the waiting time before the battery of a vehicle is charged.

A first aspect of the present disclosure relates to a navigation server including a processor. The processor is configured to acquire information on the charging mode of the battery included in each of a plurality of vehicles and to select a charging space for each of the plurality of vehicles based on the acquired information.

A second aspect of the present disclosure relates to a navigation program. The navigation program causes a processor to acquire information on the charging mode of the battery included in each of a plurality of vehicles and to select a charging space for each of the plurality of vehicles based on the acquired information.

A third aspect of the present disclosure relates to a navigation system including a first vehicle, a second vehicle, and a navigation server. The first vehicle has a first processor. The second vehicle has a second processor. The navigation server has a third processor configured to acquire information on the charging mode of the battery included in each of the first vehicle and the second vehicle and to select a charging space for each of the plurality of vehicles based on the acquired information.

According to the present disclosure, it is possible to reduce the waiting time before the battery of a vehicle is charged.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram schematically showing a navigation system according to an embodiment;

FIG. 2 is a block diagram schematically showing a configuration of the navigation system according to the embodiment;

FIG. 3 is a diagram showing the guidance of routes to charging spaces; and

FIG. 4 is a diagram showing a charging space route-guidance control routine performed by the navigation system according to the embodiment.

### DETAILED DESCRIPTION OF EMBODIMENTS

An embodiment of a navigation server, a navigation program, and a navigation system according to the present disclosure will be described below. It should be noted the present disclosure is not limited by the embodiment.

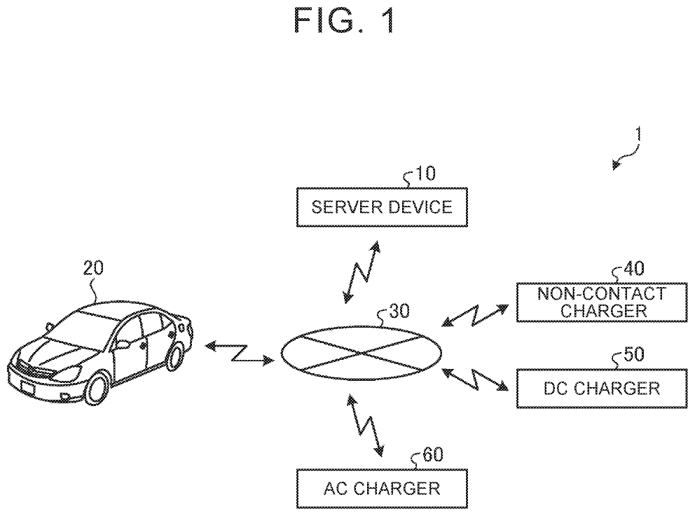

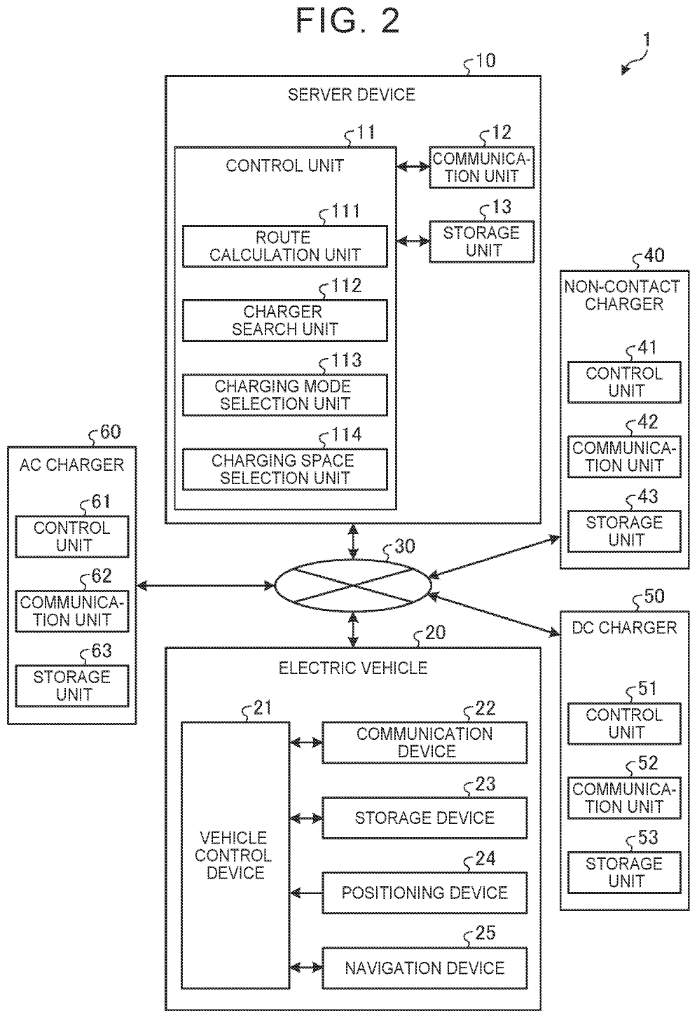

FIG. 1 is a diagram schematically showing a navigation system 1 according to the embodiment. FIG. 2 is a block diagram schematically showing a configuration of the navigation system 1 according to the embodiment.

As shown in FIG. 1, the navigation system 1 includes a server device 10, an electric vehicle 20, a network 30, a non-contact charger 40, a DC charger 50, and an AC charger 60.

The server device 10, electric vehicle 20, non-contact charger 40, DC charger 50, and AC charger 60 are configured to be able to communicate with each other through the network 30. The network 30 is a network such as the Internet network and a mobile phone network.

The server device 10 functions as a navigation server. As shown in FIG. 2, the server device 10 includes a control unit 11, a communication unit 12, and a storage unit 13.

The control unit 11 includes, in more detail, a processor such as a central processing unit (CPU), a digital signal processor (DSP), or a field-programmable gate array (FPGA), and a memory (main storage unit) such as a random access memory (RAM) and a read only memory (ROM). The control unit 11 loads a program from the storage unit 13 into the work area of the main storage unit for execution and, through the execution of the program, controls each component to achieve the function that meets the predetermined purpose. For example, through the execution of a navigation program, the control unit 11 functions as a route calculation unit 111, a charger search unit 112, a charging mode selection unit 113, and a charging space selection unit 114.

The route calculation unit 111 calculates a route along which the electric vehicle 20 is to travel. The charger search unit 112 sets a charger search range based on the travelable distance of the electric vehicle 20 and searches the chargers, included in the charger search range, for a charger to be used for charging. The charging mode selection unit 113 selects the charging mode for charging the battery of the electric vehicle 20. The charging space selection unit 114 selects a charging space to which the electric vehicle 20 is to be guided, based on the selected charging mode of the electric vehicle 20.

The communication unit 12 is configured, for example, by a local area network (LAN) interface board, a wireless communication circuit for wireless communication, and the like. The communication unit 12 is connected to the network 30 such as the Internet that is one of the public communication networks. The communication unit 12 connects to the network 30 for communication with the electric vehicle 20, the non-contact charger 40, the DC charger 50, and the AC charger 60.

The storage unit 13 is configured by recording media such as an erasable programmable ROM (EPROM), a hard disk drive (HDD), and a removable medium. Examples of removable media include a universal serial bus (USB) memory and disk storage media such as a compact disc (CD), a digital versatile disc (DVD), and a Blu-ray (registered trademark) disc (BD). The storage unit 13 can store the operating system (OS), various programs, various tables, and various databases.

The storage unit 13 may temporarily store the calculation results of the route calculation unit 111 and the charger search unit 112. In addition, the storage unit 13 may store the information acquired by the server device 10 through communication with the electric vehicle 20, such as the information on the remaining battery level (state of charge: SOC) and the information on the charging mode (for example, non-contact charging, DC charging, AC charging, etc.) of the electric vehicle 20. Furthermore, the storage unit 13 may store the charger information acquired by the server device 10 through communication with the non-contact charger 40, the DC charger 50, and the AC charger 60. The charger information includes, for example, the name of the charger, the location of the charger (for example, latitude, longitude), the charging capability (for example, fast charging or normal charging), the charging mode (for example, non-contact charging, DC charging, AC charging, etc.), and the usage condition of the charger.

The electric vehicle 20 is, for example, an electric vehicle (EV) or a plug-in hybrid electric vehicle (PHEV). The electric vehicle 20 includes a vehicle control device 21, a communication device 22, a storage device 23, a positioning device 24, and a navigation device 25. The vehicle control device 21 and the storage device 23 are physically the same as the control unit 11 and the storage unit 13 of the server device 10.

The vehicle control device 21 is an electronic control unit (ECU) that controls the overall operation of the various components mounted on the electric vehicle 20. The communication device 22, configured by a data communication module (DCM) and the like, communicates wirelessly with the server device 10 via the network 30. In the storage device 23, the information on the vehicle position detected by the positioning device 24 (hereinafter referred to as “vehicle position information”) is stored as needed.

The positioning device 24 receives radio waves from the Global Positioning System (GPS) satellites to detect the vehicle position information. Upon receiving the vehicle position information, the vehicle control device 21 periodically sends the vehicle position information to the server device 10 through the network 30. It should be noted that the method for detecting the vehicle position information is not limited to the method using GPS satellites. For example, a method implemented by combining a Light Detection and Ranging, Laser Imaging Detection and Ranging (LiDAR) and a three-dimensional digital map may be used.

The navigation device 25 sends and receives data (such as the map information and the travel route information) and the navigation program to and from the vehicle control device 21. By sending and receiving the data and the program in this way, the vehicle control device 21 supplies various command signals to the components of the electric vehicle 20 to cause the electric vehicle 20 to travel. The navigation device 25 itself may have a control unit, which includes a CPU, a RAM, and a ROM, and a recording medium.

The navigation device 25 has, in more detail, input/output units such as a touch panel display and a speaker microphone. Under the control of the vehicle control device 21, these input/output units notify the occupants of the predetermined information by displaying characters, figures, etc. on the screen of the touch panel display or by outputting voices from the speaker microphone. Furthermore, the input/output units allow the occupants of the electric vehicle 20 to operate the touch panel display, or to talk into the speaker microphone, to enter the predetermined information to the vehicle control device 21.

The navigation system 1 according to the embodiment displays a route to a charging space (charger), which has been searched for and selected by the server device 10, for example on the screen of the touch panel display of the navigation device 25. That is, the navigation system 1 according to the embodiment presents the information on a charging space (charger) to the occupants of the electric vehicle 20 through the touch panel display of the navigation device 25.

In addition to the components included in the configuration shown in FIG. 2, the electric vehicle 20 includes an inverter, a motor, a battery, and the like. The vehicle control device 21 of the electric vehicle 20 can detect the state-of-charge information and sends the detected state-of-charge information to the server device 10 as needed.

The non-contact charger 40 includes a control unit 41, a communication unit 42, and a storage unit 43. The control unit 41 includes, in more detail, a processor such as a CPU, a DSP, or an FPGA, and a memory (main storage unit) such as a RAM and a ROM. The control unit 41 loads a program from the storage unit 43 into the work area of the main storage unit for execution and, through the execution of the program, controls each component to achieve the function that meets a predetermined purpose.

The communication unit 42 is configured, for example, by a LAN interface board, a wireless communication circuit for wireless communication, and the like. The communication unit 42 is connected to the network 30 such as the Internet that is one of the public communication networks. The communication unit 42 connects to the network 30 for communication with the server device 10 and the electric vehicle 20.

The storage unit 43 is configured by recording media such as an EPROM, a hard disk drive, and a removable medium. Examples of removable media include a USB memory and disk storage media such as a CD, a DVD, and a BD. The storage unit 43 can store the operating system, various programs, various tables, and various databases.

The storage unit 43 may store the information (charger information) on the non-contact charger 40. The information on the non-contact charger 40 includes the name of the charger, the location of the charger (e.g., latitude, longitude, and area), the charging capability (e.g., fast charging or normal charging), the charging mode (non-contact charging mode), and the usage condition of the charger.

The DC charger 50 includes a control unit 51, a communication unit 52, and a storage unit 53. The control unit 51 includes, more in detail, a processor such as a CPU, a DSP, or an FPGA, and a memory (main storage unit) such as a RAM and a ROM. The control unit 51 loads a program from the storage unit 53 into the work area of the main storage unit for execution and, through the execution of the program, controls each component to achieve the function that meets the predetermined purpose.

The communication unit 52 is configured, for example, by a LAN interface board, a wireless communication circuit for wireless communication, and the like. The communication unit 52 is connected to the network 30 such as the Internet that is one of the public communication networks. The communication unit 52 connects to the network 30 for communication with the server device 10 and the electric vehicle 20.

The storage unit 53 is configured by recording media such as an EPROM, a hard disk drive, and a removable medium. Examples of removable media include a USB memory and disk storage media such as CD, a DVD, and a BD. The storage unit 53 can store the operating system, various programs, various tables, and various databases.

The storage unit 53 may store the information (charger information) on the DC charger 50. The information on the DC charger 50 includes the name of the charger, the location of the charger (e.g., latitude, longitude, and area), the charging capability (e.g., fast charging or normal charging), the charging mode (DC charging mode), and the usage condition of the charger.

The AC charger 60 includes a control unit 61, a communication unit 62, and a storage unit 63. The control unit 61 includes, in more detail, a processor such as a CPU, a DSP, or an FPGA, and a memory (main storage unit) such as a RAM and a ROM. The control unit 61 loads a program from the storage unit 63 into the work area of the main storage unit for execution and, through the execution of the program, controls each component to achieve the function that meets the predetermined purpose.

The communication unit 62 is configured, for example, by a LAN interface board, a wireless communication circuit for wireless communication, and the like. The communication unit 62 is connected to the network 30 such as the Internet that is one of the public communication networks. The communication unit 62 connects to the network 30 for communication with the server device 10 and the electric vehicle 20.

The storage unit 63 is configured by recording media such as an EPROM, a hard disk drive, and a removable medium. Examples of removable media include a USB memory and disk storage media such as a CD, a DVD, and a BD. The storage unit 63 can store the operating system, various programs, various tables, and various databases.

The storage unit 63 may store the information (charger information) on the AC charger 60. The information on the AC charger 60 includes the name of the charger, the location of the charger (e.g., latitude, longitude, and area), the charging capability (e.g., fast charging or normal charging), the charging mode (AC charging mode), and the usage condition of the charger.

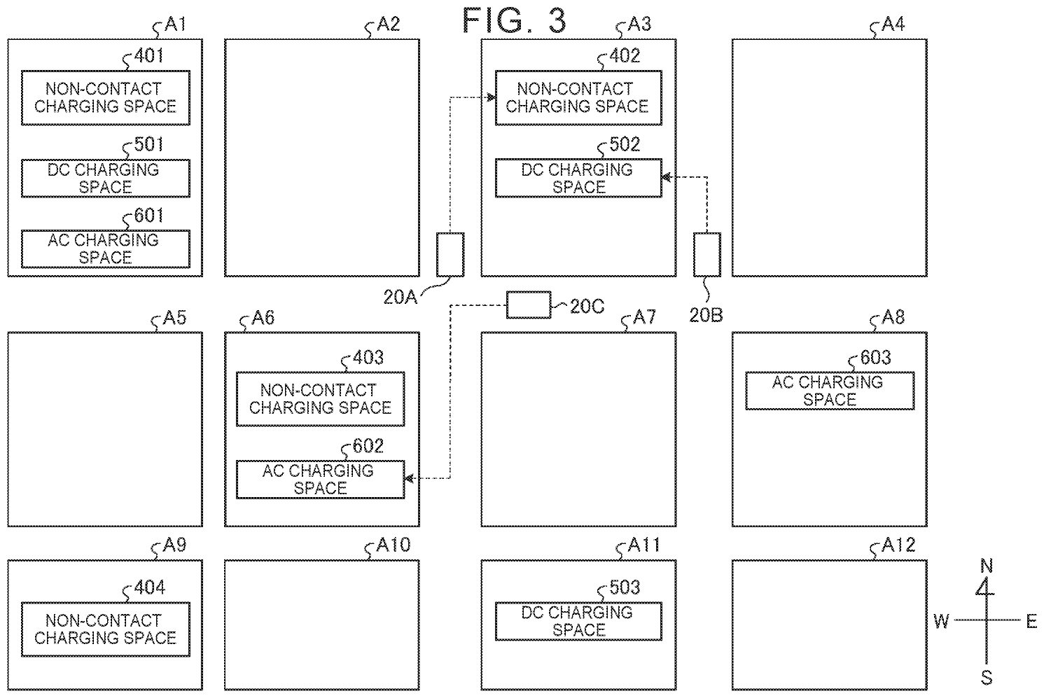

FIG. 3 is a diagram showing the guidance of routes to charging spaces. In FIG. 3, the whole area is divided into a plurality of areas A1 to A12 by three roads extending from north to south and two roads extending from east to west. Of the plurality of areas, areas A1, A3, A6, A8, A9, and A11 each have at least one of a non-contact charging space (first charging space) in which the non-contact charger 40 is installed, a DC charging space (second charging space) in which the DC charger 50 is installed, and an AC charging space (second charging space) in which the AC charger 60 is installed. More specifically, in area A1, a non-contact charging space 401, a DC charging space 501, and an AC charging space 601 are provided. In area A3, a non-contact charging space 402 and a DC charging space 502 are provided. In area A6, a non-contact charging space 403 and an AC charging space 602 are provided. In area A8, an AC charging space 603 is provided. In area A9, a non-contact charging space 404 is provided. In area A11, a DC charging space 503 is provided.

In each of the non-contact charging spaces 401, 402, 403, 404, the DC charging spaces 501, 502, 503, and the AC charging spaces 601, 602, 603, one electric vehicle 20 may be parked in one charging space for charging. The electric vehicle 20 enters and leaves each of the non-contact charging spaces 401, 402, 403, 404, DC charging spaces 501, 502, 503, and AC charging spaces 601, 602, 603 via the road adjacent to the area where the charging space is included.

In FIG. 3, one charging space is provided for the same charging mode in areas A1, A3, A6, A8, A9, and A11. Instead of this, one or more charging spaces may be provided for the same charging mode in one area.

In the non-contact charging spaces 401, 402, 403, 404, electric power is received from the non-contact charger 40 in a non-contact manner for charging the battery of the electric vehicle 20. As the method for the non-contact charging of the electric vehicle 20 by the non-contact charger 40, a known method can be used.

In the DC charging spaces 501, 502, 503, the DC charger 50 and the electric vehicle 20 are connected by a charging cable and, via the charging cable, DC power is received from the DC charger 50 for charging the battery of the electric vehicle 20. As the method for the DC charging of the electric vehicle 20 by the DC charger 50, a known method can be used.

In the AC charging spaces 601, 602, 603, the AC charger 60 and the electric vehicle 20 are connected by a charging cable and, via the charging cable, AC power is received from the AC charger 60 for charging the battery of the electric vehicle 20. As the method for the AC charging of the electric vehicle 20 by the AC charger 60, a known method can be used.

An electric vehicle 20A (first vehicle) shown in FIG. 3 is configured to be chargeable in the non-contact charging mode (first charging mode) and the DC charging mode (second charging mode). An electric vehicle 20B (second vehicle) is configured to be chargeable in the DC charging mode (second charging mode). An electric vehicle 20C is configured to be chargeable in the AC charging mode and the DC charging mode.

In FIG. 3, when a power receiving request is received from the electric vehicles 20A, 20B at about the same time, the server device 10 selects charging spaces based on the charging mode information on the electric vehicles 20A, 20B and guides the electric vehicles 20A, 20B to the selected charging spaces.

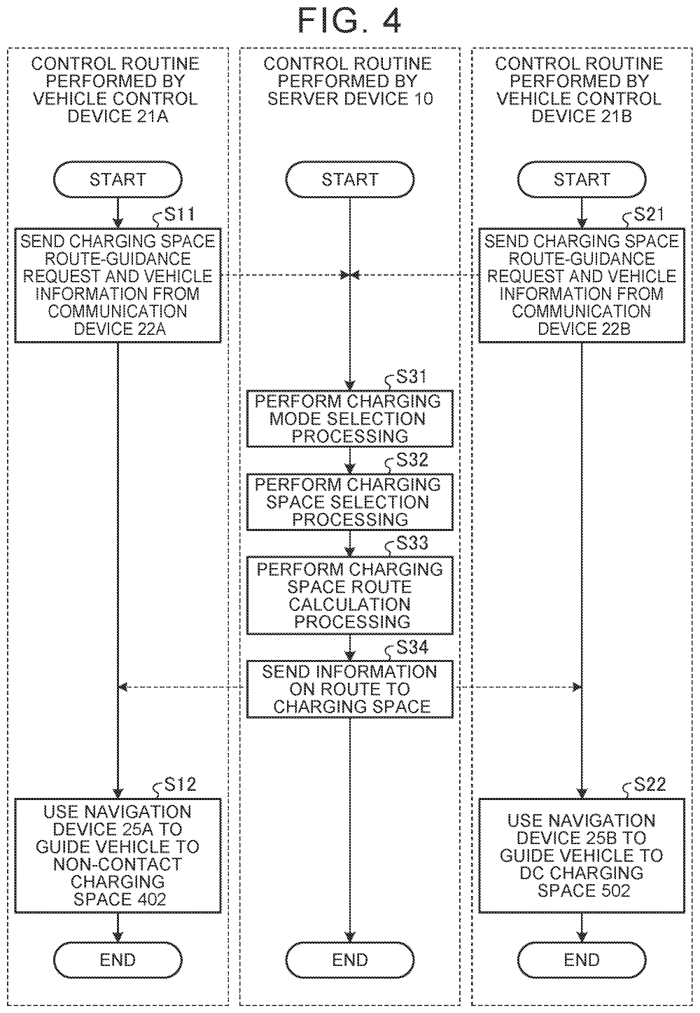

FIG. 4 is a diagram showing a charging space route-guidance control routine performed by the navigation system 1 in the embodiment. First, with reference to FIG. 3 and FIG. 4, the following describes how the navigation system 1 guides the two electric vehicles 20A, 20B, to the charging spaces. Note that the charging space route-guidance control routine shown in FIG. 4 is executed in cooperation among the server device 10 and the electric vehicles 20A, 20B. More specifically, this routine is composed of the control routine executed by the server device 10, the control routine executed by the electric vehicle 20A, and the control routine executed by the electric vehicle 20B. In the description of the charging space route-guidance control routine shown in FIG. 4, it is assumed that, based on the travelable distances of the electric vehicles 20A, 20B, the charger search unit 112 of the server device 10 has selected the chargers in area A3 as the chargers to be used for charging.

When this routine is started, the vehicle control devices 21A, 21B each send, in steps S11 and S21, a charging space route-guidance request and the vehicle information to the server device 10. That is, the vehicle control device 21A sends the charging space route-guidance request and the first vehicle information (first information) from the communication device 22A to the server device 10 via the network 30. In this case, the first vehicle information (first information) includes the charging mode information indicating that the battery of the electric vehicle 20A can be charged in both the non-contact charging mode and the DC charging mode. The vehicle control device 21B sends the charging space route-guidance request and the second vehicle information (second information) from the communication device 22B to the server device 10 via network 30. In this case, the second vehicle information (second information) includes the charging mode information indicating that the battery of the electric vehicle 20B can be charged only in the DC charging mode.

Next, in step S31, the control unit 11 of the server device 10 causes the charging mode selection unit 113 to perform the charging mode selection processing based on the charging space route-guidance requests and the vehicle information received from the electric vehicles 20A, 20B via the communication unit 12. In the charging mode selection processing, the charging mode selection unit 113 selects the charging modes in which to charge the batteries of the electric vehicles 20A, 20B. Since the electric vehicle 20B supports only the DC charging mode, the charging mode selection unit 113 selects the DC charging mode as the charging mode of the electric vehicle 20B. On the other hand, since the electric vehicle 20A supports both the non-contact charging mode and the DC charging mode, the charging mode selection unit 113 selects the non-contact charging mode as the charging mode of the electric vehicle 20A.

Next, in step S32, the control unit 11 of the server device 10 causes the charging space selection unit 114 to perform the charging space selection processing based on the selected charging modes. In the charging space selection processing, the charging space selection unit 114 selects charging spaces, to which the electric vehicles 20A, 20B are to be guided, from the non-contact charging space 402 and the DC charging space 502 included in area A3. The charging space selection unit 114 selects the non-contact charging space 402 for the electric vehicle 20A for which the non-contact charging mode has been selected, and the DC charging space 502 for the electric vehicle 20B for which the DC charging mode has been selected.

Next, in step S33, the control unit 11 of the server device 10 causes the route calculation unit 111 to perform the charging space route calculation processing to calculate the routes to the selected charging spaces. The route calculation unit 111 calculates the route from the current position of the electric vehicle 20A to the non-contact charging space 402. In addition, the route calculation unit 111 calculates the route from the current position of the electric vehicle 20B to the DC charging space 502.

Next, in step S34, the control unit 11 of the server device 10 sends the information on the routes to the charging spaces, calculated corresponding to each of the electric vehicles 20A, 20B, from the communication unit 12 to electric vehicles 20A, 20B via the network 30 and then ends this routine.

Next, in steps S12 and S22, each of the vehicle control devices 21A, 21B uses the navigation devices 25A, 25B, respectively, to guide the vehicle to the charging space based on the received information on the route to the charging space. That is, the navigation device 25A guides the vehicle along the route to the non-contact charging space 402 based on the information on the route to the non-contact charging space 402. Similarly, the navigation device 25B guides the vehicle along the route to the DC charging space 502 based on the information on the route to the DC charging space 502. After guiding the vehicles along the routes to the charging spaces via the navigation devices 25A, 25B, the vehicle control devices 21A, 21B end this routine. Note that, when each of the electric vehicles 20A, 20B has the autonomous driving function for autonomous traveling, each of the navigation devices 25A, 25B causes the vehicles 20A, 20B to travel autonomously according to the guidance of the route to the charging space.

The navigation system 1 according to the embodiment can prevent a situation in which, while one of the two electric vehicles 20 is charging the battery, the other electric vehicle 20 must wait in the case when both electric vehicles 20A, 20B, each capable of charging the battery in the DC charging mode, are guided to the same DC charging space 502 and, therefore, the DC charging space 502 is congested.

When the non-contact charging space 402 is being used for charging the battery of another electric vehicle 20, the control unit 11 of the server device 10 may select a free non-contact charging space, which is one of the non-contact charging spaces 401, 403, 404 in areas A1, A6, and A9, and send the information on the route to the selected charging space to the electric vehicle 20A. This makes it possible to reduce the waiting time before the battery of the electric vehicle 20A is charged.

Furthermore, when the communication unit 12 communicates with the DC charger 50 provided in the DC charging space 502 and finds that the DC charging space 502 is being used for charging the battery of another electric vehicle 20, the server device 10 may send the information on the route to another charging space to the electric vehicle 20B. For example, the server device 10 causes the communication unit 12 to communicate with the DC charger 50, provided in each of the DC charging spaces 501, 503 in areas A1 and A11, to select a free charging space, which is one of the DC charging spaces 501, 503, and sends the information on the route to the selected charging space to the electric vehicle 20B. This makes it possible to reduce the waiting time before the battery of the electric vehicle 20B is charged.

Furthermore, when there is a need to guide the electric vehicle 20C, in addition to the electric vehicles 20A, 20B, to a charging space, the server device 10 may guide the electric vehicles 20A, 20B, 20C to charging spaces (chargers) deferring from each other in the charging mode. For example, the server device 10 guides the electric vehicle 20A to the non-contact charging space 402 in area A3, the electric vehicle 20B to the DC charging space 502 in area A3, and the electric vehicle 20C to the AC charging space 602 in area A6. Guiding the electric vehicles as described above can prevent a situation in which, while one of the electric vehicles 20 is charging the battery, the other electric vehicles 20 must wait in the case when the electric vehicles 20A, 20B, 20C, each capable of charging the battery in the DC charging mode, are guided to the same DC charging space 502 and, therefore, the DC charging space 502 is congested.

In the above case, when the AC charging space 602 in the area A6 is being used for charging the battery of another electric vehicle 20, the control unit 11 of the server device 10 may select a free charging space, which is one of the AC charging spaces 601, 603 in areas A1 and A8, and send the information on the route to the selected charging space to the electric vehicle 20C. This makes it possible to reduce the waiting time before the battery of the electric vehicle 20C is charged.

The charging mode for charging the battery of the electric vehicle 20 is not limited to the non-contact charging mode, the DC charging mode, and the AC charging mode. For example, the AC charging mode may be divided into the normal AC charging mode using single-phase AC 100V or 200V and the fast AC charging mode using three-phase AC 200V. In this case, in accordance with either the normal AC charging mode or the fast AC charging mode of the electric vehicle 20, the control unit 11 of the server device 10 may select a charging space where the normal AC charger or the fast AC charger is provided and guide the electric vehicle 20 along the route to the selected charging space.

In the navigation system 1 according to the embodiment, the server device 10 is configured to calculate the route to a charging space. Instead of this, the processor provided in at least one of the server device 10, the electric vehicle 20, and the charger may be used to calculate the route to a charging space so that the information on the route to the charging space can be sent eventually to the electric vehicle 20.

Further effects and modifications can be easily derived by those skilled in the art. The broader aspects of the present disclosure are not limited to the specific details and typical embodiments expressed and described above. Accordingly, various modifications can be made without departing from the spirit or scope of the general disclosive concept as defined by the appended claims and their equivalents

What is claimed is:

1. A navigation server comprising a processor configured to acquire information on a charging mode of a battery included in each of a plurality of vehicles and to select a charging space for each of the plurality of vehicles based on the acquired information.

2. The navigation server according to claim 1, wherein the processor is configured to perform charging space route calculation processing in which a route to the charging space selected for each of the vehicles is calculated.

3. The navigation server according to claim 2, wherein the processor is configured to output information on the route calculated by the charging space route calculation processing for each of the vehicles.

4. The navigation server according to claim 1, wherein the processor is configured to acquire first information and second information and to perform charging space selection processing in which, from a first charging space and a second charging space, the second charging space is selected for a second vehicle and the first charging space is selected for a first vehicle, the first information indicating that the first vehicle is able to charge a battery in any of a first charging mode and a second charging mode, the second information indicating that the second vehicle is able to charge a battery in at least the second charging mode, the first charging space being a charring space where the battery is able to be charged in the first charging mode, the second charging space being a charging space where the battery is able to be charged in the second charging mode.

5. The navigation server according to claim 4, wherein the processor is configured to acquire the first information from the first vehicle, to acquire the second information from the second vehicle, and to perform charging mode selection processing in which a charging mode for charging the battery of each of the first vehicle and the second vehicle is selected.

6. The navigation server according to claim 4, wherein the first charging mode and the second charging mode are different in the charging mode from each other and are each one of a non-contact charging mode, a DC charging mode, and an AC charging mode.

7. A navigation program causing a processor to acquire information on a charging mode of a battery included in each of a plurality of vehicles and to select a charging space for each of the plurality of vehicles based on the acquired information.

8. The navigation program according to claim 7, the navigation program causing the processor to perform charging space route calculation processing in which a route to the charging space selected for each of the vehicles is calculated.

9. The navigation program according to claim 8, the navigation program causing the processor to output information on the route calculated by the charging space route calculation processing for each of the vehicles.

10. The navigation program according to claim 7, the navigation program causing the processor to acquire first information and second information and to perform charging space selection processing in which, from a first charging space and a second charging space, the second charging space is selected for a second vehicle and the first charging space is selected for a first vehicle, the first information indicating that the first vehicle is able to charge a battery in any of a first charging mode and a second charging mode, the second information indicating that the second vehicle is able to charge a battery in at least the second charging mode, the first charging space being a charring space where the battery is able to be charged in the first charging mode, the second charging space being a charging space where the battery is able to be charged in the second charging mode.

11. The navigation program according to claim 10, the navigation program causing the processor to acquire the first information from the first vehicle, to acquire the second information from the second vehicle, and to perform charging mode selection processing in which a charging mode for charging the battery of each of the first vehicle and the second vehicle is selected.

12. The navigation program according to claim 10, wherein the first charging mode and the second charging mode are different in the charging mode from each other and are each one of a non-contact charging mode, a DC charging mode, and an AC charging mode.

13. A navigation system comprising:
a first vehicle having a first processor;
a second vehicle having a second processor; and
a navigation server having a third processor, the third processor being configured to acquire information on a charging mode of a battery included in each of the first vehicle and the second vehicle and to select a charging space for each of the first vehicle and the second vehicle based on the acquired information.

14. The navigation system according to claim 13, wherein the third processor is configured to perform charging space route calculation processing in which a route to the charging space selected for each of the vehicles is calculated.

15. The navigation system according to claim 14, wherein the third processor is configured to output information on the route calculated by the charging space route calculation processing for each of the vehicles.

16. The navigation system according to claim 15, wherein the first processor and the second processor are each configured to guide the vehicle to the charging space based on the information on the route.

17. The navigation system according to claim 15, wherein the first processor and the second processor are each configured to guide the vehicle to the charging space by causing the first vehicle and the second vehicle to travel autonomously based on the information on the route.

18. The navigation system according to claim 13, wherein the third processor is configured to acquire first information and second information and to perform charging space selection processing in which, from a first charging space and a second charging space, the second charging space is selected for the second vehicle and the first charging space is selected for the first vehicle, the first information indicating that the first vehicle is able to charge a battery in any of a first charging mode and a second charging mode, the second information indicating that the second vehicle is able to charge a battery in at least the second charging mode, the first charging space being a charring space where the battery is able to be charged in the first charging mode, the second charging space being a charging space where the battery is able to be charged in the second charging mode.

19. The navigation system according to claim 18, wherein the third processor is configured to acquire the first information from the first vehicle, to acquire the second information from the second vehicle, and to perform charging mode selection processing in which a charging mode for charging the battery of each of the first vehicle and the second vehicle is selected.

20. The navigation system according to claim 18, wherein the first charging mode and the second charging mode are different in the charging mode from each other and are each one of a non-contact charging mode, a DC charging mode, and an AC charging mode.
